(19) United States
(12) Patent Application Publication
(10) Pub. No.: US 2015/0046176 A1
(43) Pub. Date: Feb. 12, 2015

(54) SYSTEM AND METHOD FOR IMPROVING NEUROLOGIST'S WORKFLOW ON ALZEIMER'S DISEASE

(71) Applicant: KONINKLIJKE PHILIPS N.V., Eindhoven (NL)

(72) Inventors: Ye Xu, Milford, CT (US); Stewart Young, Hamburg (DE); Hans Zou, Windsor, NJ (US); Caitlyn Marie Chiofolo, New Hyde Park, NY (US)

(21) Appl. No.: 14/388,072

(22) PCT Filed: Mar. 22, 2013
(86) PCT No.: PCT/IB2013/052295

§ 371 Date: Sep. 25, 2014

Related U.S. Application Data
(60) Provisional application No. 61/617,255, filed on Mar. 29, 2012.

(51) Int. Cl. G06F 19/00

(52) U.S. Cl. CPC G06F 19/327; G06F 19/345
USPC 705/2

(57) ABSTRACT

A system for improving workflow including one or more clinical data sources which collect patient data from a patient. A patient information system stores the patient data. A clinical decision support system including one or more processors programmed to receive the patient data from the patient, generate quantified information based on a statistical model for each type of patient data, diagnose the patient based on the quantified information, generate a recommendation based on the diagnosis and the quantified information, and display the recommendation.

The present application relates to clinical decision making. It finds particular application in conjunction with clinical decision support systems and will be described with particular reference thereto. However, it is to be understood that it also finds application in other usage scenarios and is not necessarily limited to the aforementioned application.

Dementia is caused by various diseases and conditions that result in damaged brains cells or connections between brain cells. Alzheimer's disease (AD) is the most common type of dementia accounting for an estimated 60%-80% of the cases. The symptoms of AD include memory loss, language deterioration, impaired ability to mentally manipulate visual information, poor judgment, confusion, restlessness, mood swings, and the like. As the disease progresses, the individual's cognitive and function abilities decline. Diagnosis of AD is complicated for neurologists. With the exception of certain inherited forms of the disease, the cause or causes of AD remain unknown. A diagnosis of AD is typically made by a neurologist who conducts a series of cognitive tests of an individual based on the cognitive impairment (memory, language, attention, processing speed, and spatial ability), behavioral disturbances, and motor impairment. Even though a final diagnosis of AD can only be established via autopsy samples, neurologists often establish a diagnosis of probable AD based on the clinical patient evaluations.

In order to correctly evaluate an individual's level of cognitive function, a neurologist must evaluate the results of a large number of tests and scans before a diagnosis can be established. Typically, an individual's cognitive function is evaluated based on at least one of neurophysiological tests, biomarker information, medical imaging data, and the like. For example, many neuropsychological tests are utilized to evaluate cognitive function including Mini-Mental State Exam (MMSE), Alzheimer's Disease Assessment Scale-cognitive subscale (ADAS-cog), Wechsler Digits Forward and Digits Backward, Clinical Dementia Rating (CDR), Logical Memory, Clock Drawing and Clock Copying, and the like. Each test evaluates a patient's cognitive ability in different functional areas such as semantic memory, perceptual speed, and the like. Additionally, biomarker information including but not limited to gene-based biomarkers, such as amyloid beta (A•) accumulation sampled from cerebrospinal fluid (CSF), are also used to evaluate cognitive function by monitoring the functional and structural brain alterations of an individual. Further, medical imaging data, such as MRI image data, FDG-PET image data, PET image data, and the like are utilized to determine if an individual has atrophy of the hippocampus, which is highly correlated with AD.

The current clinical practice for assessment of dementia is mainly based on the measurement of cognitive impairment using an absolute scale, such as MMSE, CDR. Although this approach can provide a snap shot of dementia status; it cannot provide a reliable prognosis of dementia progression until multiple chronicle diagnostic data points are collected. As previously mentioned, one of the main causes of dementia is AD. Although, AD has characteristic pathological markers in both body fluid and brain anatomic morphology, clinical symptoms of AD patients, especially cognitive impairment can have a widely spread spectrum. For example, individuals may not have any observable cognitive impairment but already show typical AD anatomic biomarkers. Individuals who show milder cognitive impairment at similar AD pathological stages have a slower progression rate of clinical dementia despite a similar progression rate of pathological markers. Similarly, patients who show severer cognitive impairment at similar AD pathological stages have a faster than average progression rate of their clinical dementia. In clinical practice, all treatment and disease management are focused on clinical symptoms. Therefore, correct and quick prognosis of dementia progression is very critical for optimal therapy and disease management. Based on a large set of clinical data, it is possible to build a statistic correlation between biomarker scale and dementia staging. However, because of above mentioned broad cognitive impairment spectrum (including individuals who are cognitively normal, those with MCI, and those with dementia while at the same AD pathological stage), applying such median correlation to individuals generates poor prognosis. Using two or more data points of an individual patient can provide a more reliable prognosis, but it is time consuming and may miss optimal treatment windows.

Further, currently available clinical decision support (CDS) systems for AD do not offer intelligent mechanisms to improve workflow for neurologists based on their needs. None of these systems provides non-biased quantified information to enable second opinions on the diagnosis of AD and adaptive recommendations to improve neurologists' workflow. These specific characteristics are important for clinical decision making in patient management, such as making recommendation on next order of scans and tests, and drug prescription or follow up. To improve workflow for neurologists, a need exists for CDS systems to have a mechanism to provide them quantified and statistical information, presented in a form which supports the user in their interpretation of the collected data. The purpose of this quantified information is to provide an overview of the typical variability within a population of normal control subjects, the patients confirmed to be suffering from specified diseases, and the patients with prodromal disease often termed mild cognitive impairment. Another need exists to provide a user interface to show the statistical data and clearly indicate where the current patient sits among different group of population. Furthermore, a need exists for CDS systems to provide recommendations to neurologists automatically, such as lifestyle change, next order of scans and tests, drug prescription etc., based on all available information of patients, including neuropsychological tests, scans, biomarkers, and the like.

The present application provides new and improved method and system which overcomes the above-referenced problems and others.

In accordance with one aspect, a system for improving workflow is provided. The system comprising one or more clinical data sources which collect patient data from a patient. A patient information system stores the patient data. A clinical decision support system including one or more processors programmed to receive the patient data from the patient, generate quantified information based on a statistical model for each type of patient data, diagnose the patient based on the quantified information, generate a recommendation based on the diagnosis and the quantified information, and display the recommendation.

In accordance with another aspect, a method for improving workflow is provided. The method comprising receiving patient data for a patient, the patient data including clinical data collected from the patient, generating quantified information based on a statistical model for each type of patient data, diagnosing the patient based on the quantified information, generating a recommendation based on the diagnosis and the quantified information, and displaying the recommendation.

In accordance with another aspect, a method for prognosis of dementia progression is provided. The method comprising calculating a biomarker staging scale and cognitive impairment stating scale from patient data for each patient of a population, calculating a correlation curve between the biomarker staging scale and cognitive impairment stating scale of the population, and prognosis patient data of a current patient according to the correlation curve of the population.

One advantage resides in the visualization of quantified information.

Another advantage resides in providing a second opinion on the diagnosis of AD.

Another advantage resides in providing recommendations to improve neurologist's workflow.

Still further advantages of the present invention will be appreciated to those of ordinary skill in the art upon reading and understanding the following detailed description.

The invention may take form in various components and arrangements of components, and in various steps and arrangements of steps. The drawings are only for purposes of illustrating the preferred embodiments and are not to be construed as limiting the invention.

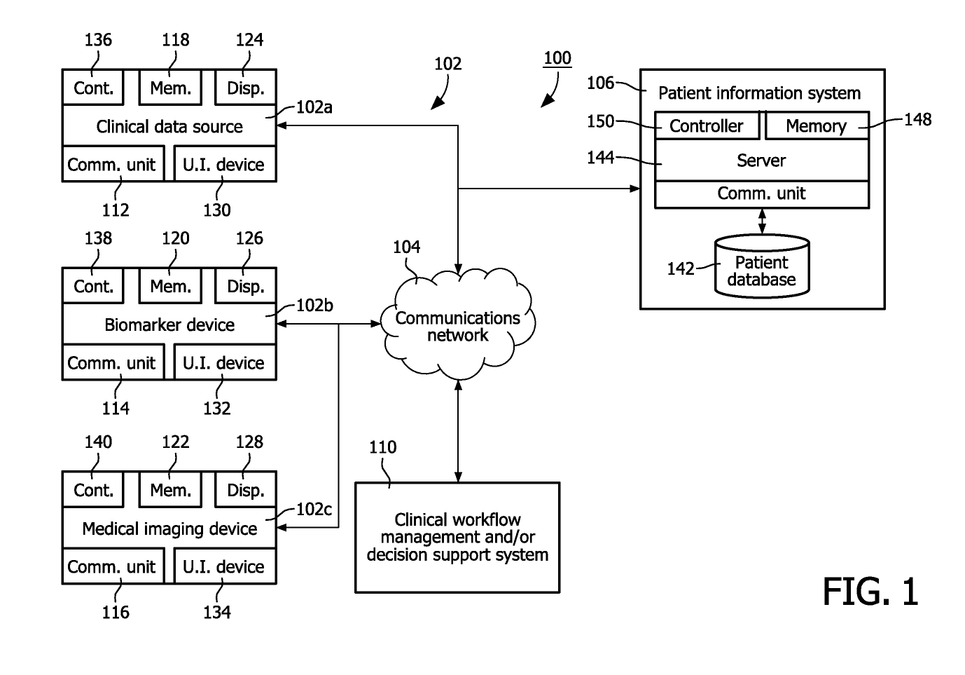

FIG. 1 is a block diagram an information technology (IT) infrastructure of a medical institution according to aspects of the present disclosure;

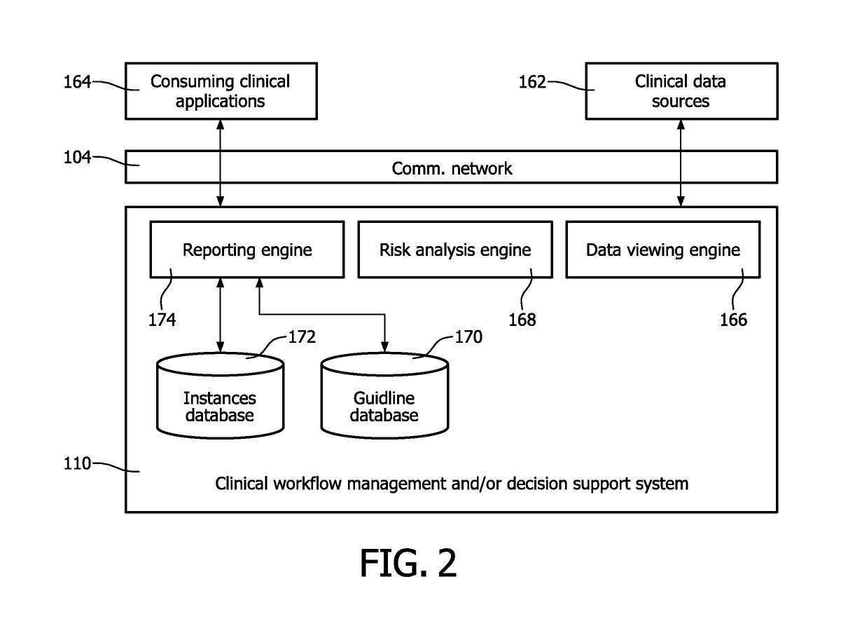

FIG. 2 is a block diagram of functional components of a clinical decision support and/or workflow management (CDS/WM) system according to aspects of the present disclosure.

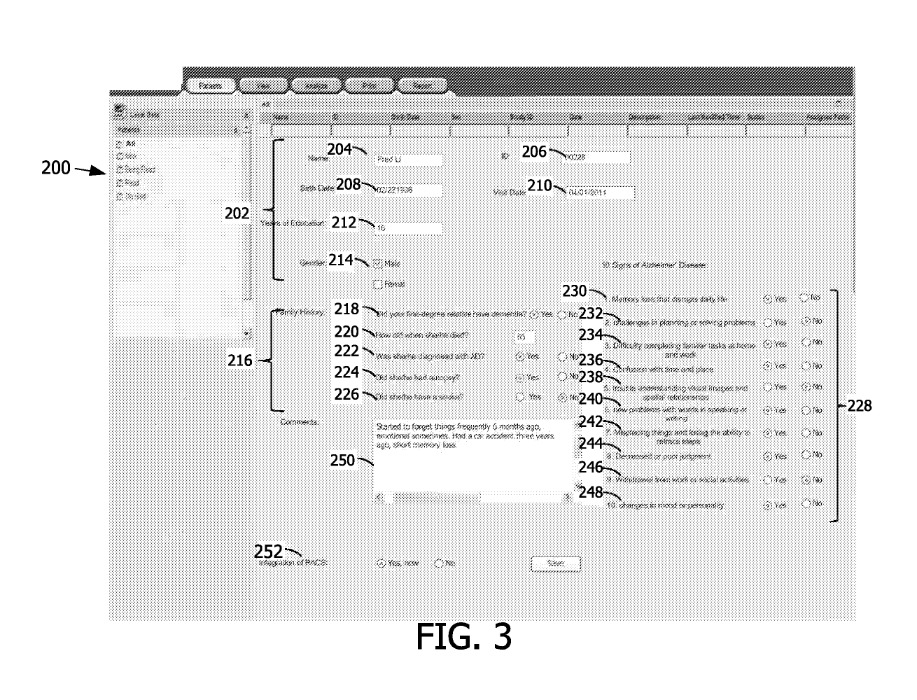

FIG. 3 is a data input interface of a CDS/WM system according to aspects of the present disclosure;

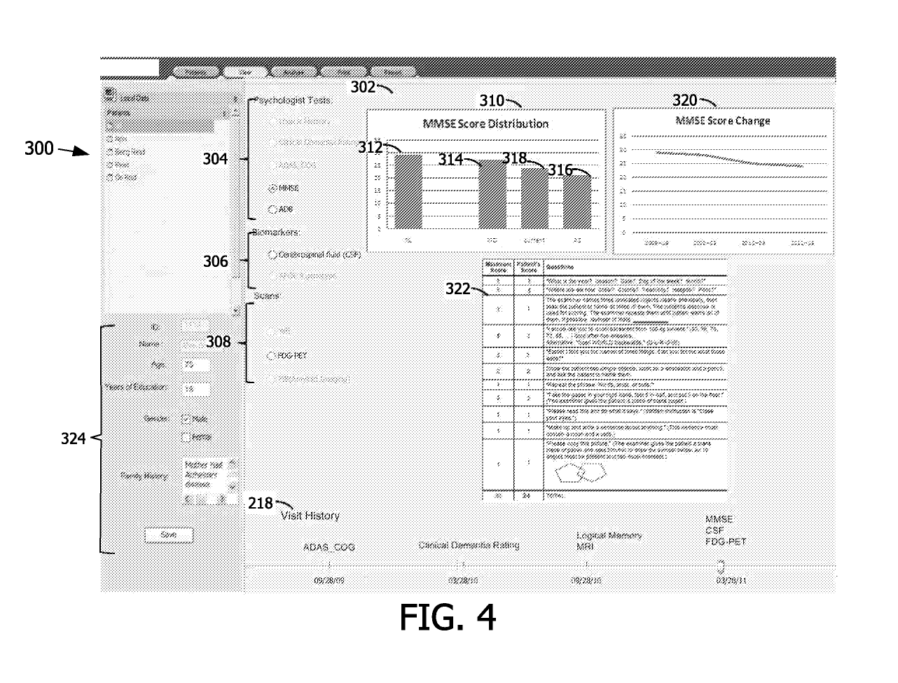

FIG. 4 is a data viewing interface of a CDS/WM system according to aspects of the present disclosure;

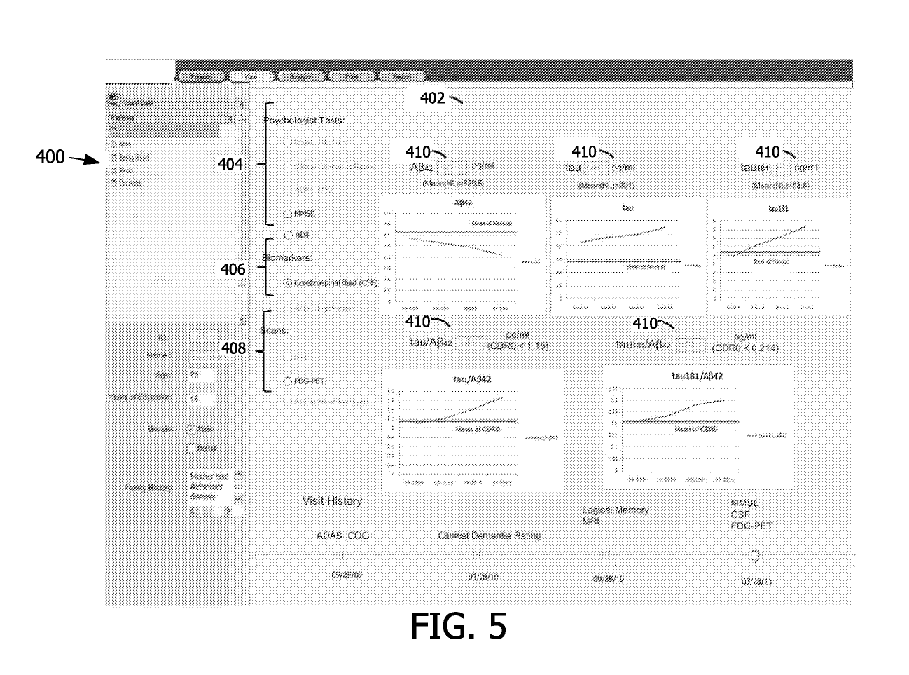

FIG. 5 is another data viewing interface of a CDS/WM system according to aspects of the present disclosure;

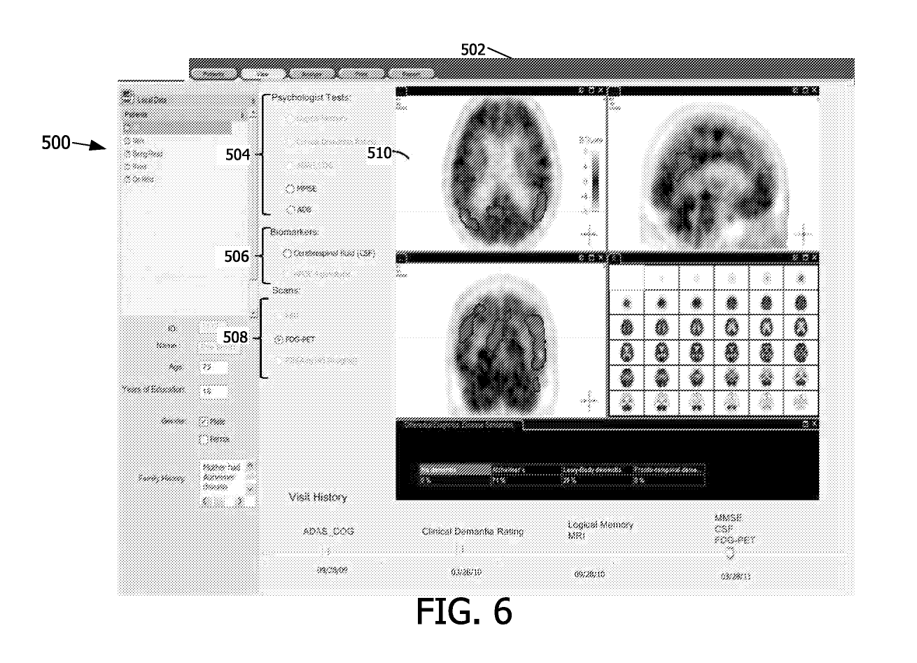

FIG. 6 is another data viewing interface of a CDS/WM system according to aspects of the present disclosure;

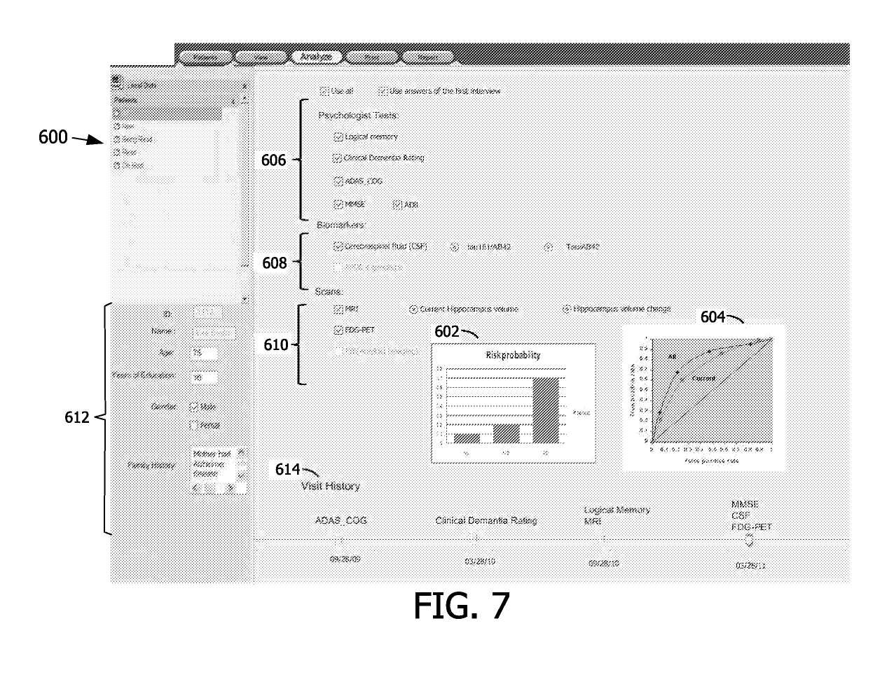

FIG. 7 is a risk analysis interface of a CDS/WM system according to aspects of the present disclosure;

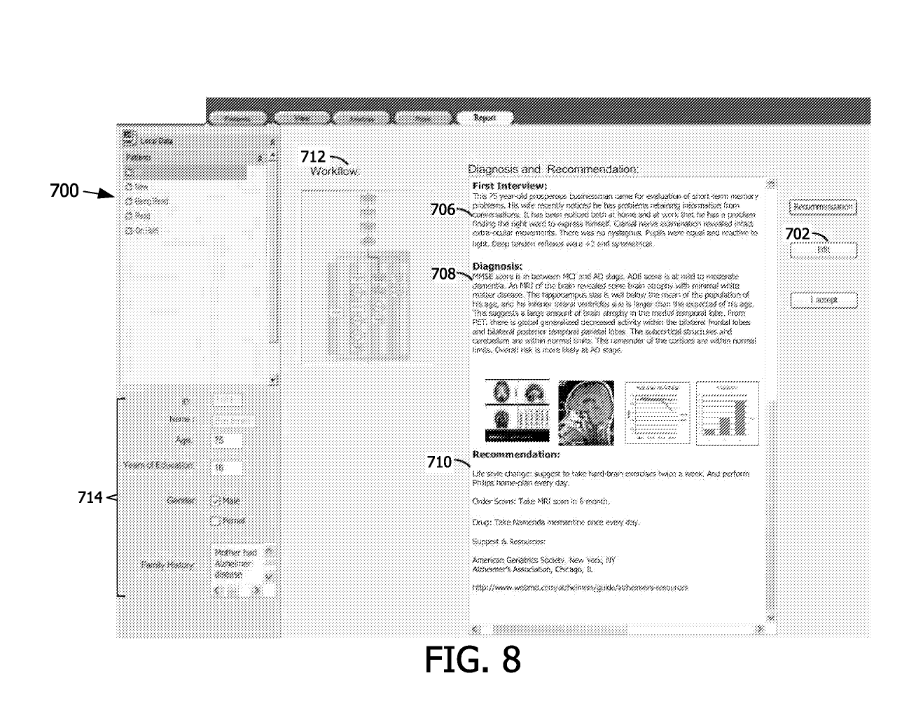

FIG. 8 is a reporting interface of a CDS/WM system according to aspects of the present disclosure;

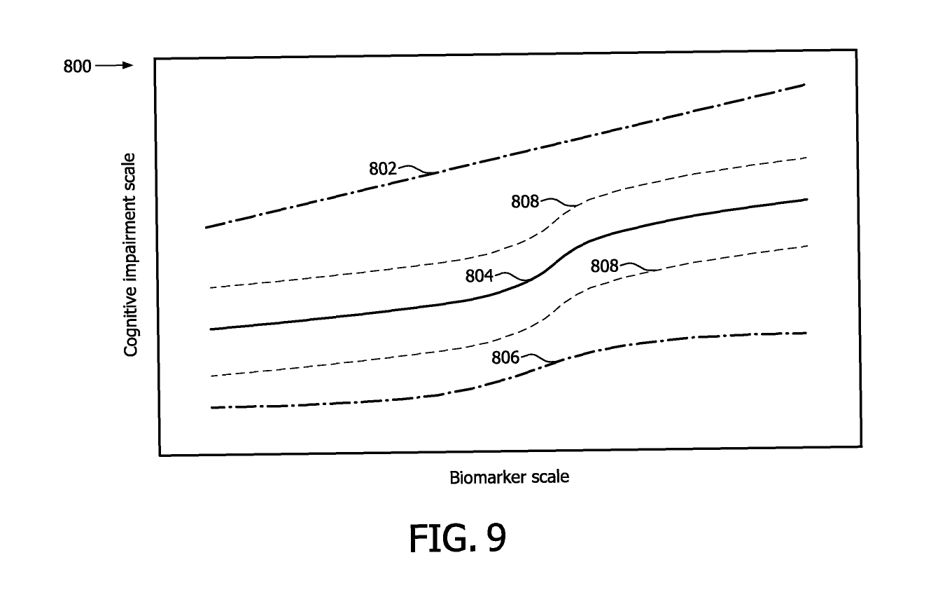

FIG. 9 is a median correlation curve interface of the CDS/WM system according to aspects of the present disclosure;

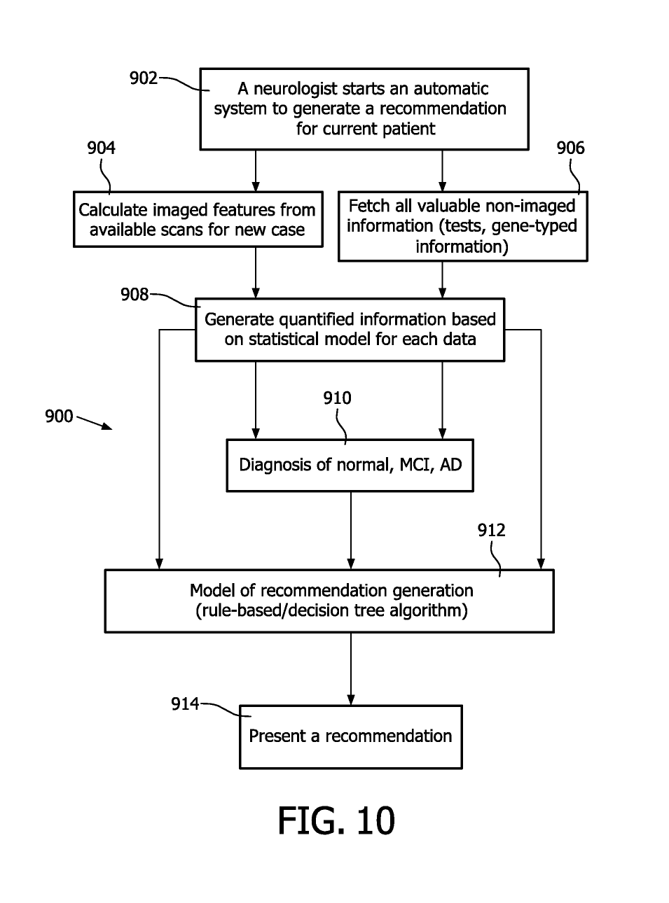

FIG. 10 illustrates the operation of a CDS/WM system according to aspects of the present disclosure.

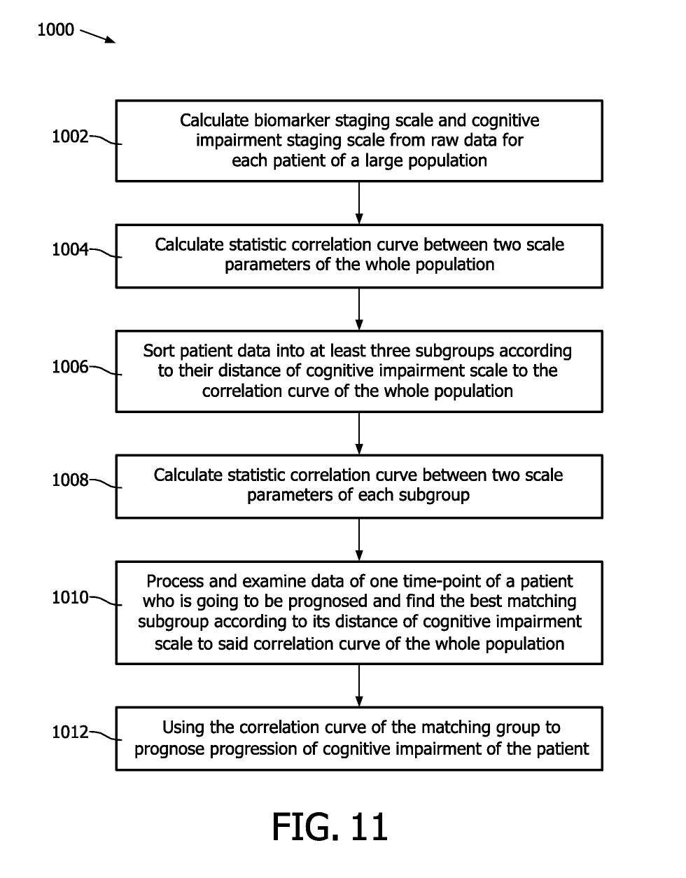

FIG. 11 illustrates another operation of a CDS/WM system according to aspects of the present disclosure.

With reference to FIG. 1, a block diagram an information technology (IT) infrastructure 100 of a medical institution, such as a hospital, is provided. The IT infrastructure 100 typically includes one or more clinical devices 102, a communications network 104, a patient information system 106, a clinical workflow management and/or decision support (CDS/WM) system 110, and the like. However, it is to be understood that more or less components and/or different arrangements of components are contemplated.

The clinical device(s) 102 include one or more clinical data sources, one or more consuming clinical applications, one or more of patient monitors, devices at patient beds, mobile communications devices carried by clinicians, clinician workstations, one or more medical imaging devices, one or more biomarker information devices, and the like at various physical locations in the medical institution. Further, each of the clinical device(s) 102 is associated with one or more patients and/or one or more clinicians. Each of the patient(s) associated with the clinical device(s) 102 is associated with one or more clinical problems, such as Alzheimer's diseases or neurological medical conditions.

As illustrated, the clinical device(s) 102 include a clinical data source 102a, a biomarker device 102b, and a medical imaging device 102c. Others, of course, are contemplated. Communications units 112, 114, 116 of the clinical device(s) 102 facilitate communication with external systems and/or databases, such as the CDS/WM system 110, via the communications network 104. Memories 118, 120, 122 of the clinical device(s) 102 store executable instructions for performing one of more of the functions associated with the clinical device(s) 102. Displays 124, 126, 128 of the clinical device(s) 102 allow the clinical device(s) 102 to display data and/or messages for the benefit of corresponding users. User input devices 130, 132, 134 of the clinical device(s) 102 allow the corresponding users of the clinical device(s) 102 to interact with the clinical device(s) 102 and/or respond to messages displayed on the displays 124, 126, 128. Controllers 136, 138, 140 of the clinical device(s) 102 execute instructions stored on the memories 118, 120, 122 to carry out the functions associated with the clinical device(s) 102.

The communications network 104 allows communication between components of the medical institution connected thereto, such as the CDS/WM system 110 and the clinical device(s) 102, and is suitable for the transfer of digital data between the components. Suitably, the communications network 104 is a local area network. However, it is contemplated that the communications network 104 is one or more of the Internet, a wide area network, a wireless network, a wired network, a cellular network, a data bus, such as USB and I2C, and the like.

The patient information system 106 acts as a central repository of electronic medical records (EMRs) for patient data. Patient data from the clinical device(s) 102 and other devices generating patient data are suitably stored in the patient information system 106. In some instances, patient data are received directly from the source of the patient data, and, in other instances, patient data are received indirectly from the source of the patient data. For example, the patient information system 106 stores and tracks all patient visits, tests and results; treatments at different time period of visits, and the like.

Typically, the patient information system 106 includes one of more of a database 142, a server 144, and the like. The database 142 stores EMRs for patients of the medical institution. It is also contemplated that the database 142 stores EMRs for patients of other medical institutions, statistical models for each data type of the patient data, patient data of a suitable comparison population, published clinical data and results, clinical literature, reference values of normal control subjects, patients with confirmed forms of specified diseases, patients with prodromal disease (MCI), and the like. The server 144 allows components of the medical institution to access to the stored information via the communications network 104. A communications unit of the server 144 facilitates communication between the server 144 and external devices, such as the clinical device(s) 102, via the communications network 104. The communications unit 146 further facilitates communication with the database 142 of the patient information system 106. A memory 148 of the server 144 stores executable instructions for performing one or more of the functions associated with the server 144. A controller 150 of the server 144 executes instructions stored on the memory 148 to carry out the functions associated with the server 144.

The CDS/WM system 110 receives patient data from one or more clinical data sources 162 (see FIG. 2) and, in certain embodiments, provides quantified and statistical information presented in a form which supports interpretation of the collected data, provides diagnostic probability that a current patient belongs to the normal, mild cognitively impaired (MCI), or AD patient groups, provides general reports on patients visits such as a summary of the impression of the patients first interview, a summary of the patients risk analysis results, and summary of findings on scans, along with the images, and provides clinical recommendations based on clinical protocols and/or clinical guidelines to one or more consuming clinical applications 164 (see FIG. 2).

The clinical data sources 162 provide patient data for associated patients to the CDS/WM system 110. For example, the clinical data sources 162 enable neurologists or supporting staff to input a patient's demographic and clinical information including but not limited to information gathered from the patient's first interview by neurologists, such as family history and the like, and assessments of the patient's first impression on signs of AD. The clinical data sources 162 also enable patients or their relatives to input their own demographic information, such as age, years of education, gender, and the like. The patient data suitably includes clinical data, such as patient symptoms (e.g., chief complaints), patient findings (e.g., physical and neurological exam findings), biomarker data (e.g., biomarker information), physiological data (e.g., blood pressure), image data (e.g. PET images utilizing amyloid tracers), workflow data, identification data (e.g., patient IDs), statistical models for each data type of the patient data, patient data of a suitable comparison population, historical patient data, published clinical data and results, clinical literature, family patient data, reference values of normal control subjects, patients with confirmed forms of specified diseases, patients with prodromal disease (MCI),and the like. The patient data (both clinical data and workflow data) is documented electronically with time stamps and is accessible by the CDS/WM system 110. It is contemplated that the workflow data identifies, for example, one or more of care steps performed, care steps currently being performed, care steps yet to be performed, and the like.

The consuming clinical applications 164 receive the quantified and statistical information presented in a form which supports interpretation of the collected data, diagnostic probability that a current patient belongs to the normal, mild cognitively impaired (MCI), or AD patient groups, general reports on patients visits, summary of the patient's risk analysis results, summary of findings on scans, and clinical recommendations for associated patients from the CDS/WM system 110. The clinical recommendations may include lifestyle changes, next order of scans or tests, drug prescriptions and dosages, reminders, alerts, background information, and the like that aim to assist clinicians with the treatment of the associated patients. To receive clinical information and recommendations for a patient, a consuming clinical application suitably registers with the CDS/WM system 110 to receive clinical information and recommendations for the patient.

The clinical data sources 162 suitably include at least one of: (1) one or more of the clinical devices 102; (2) the patient information system 106; (3) one or more of the auxiliary systems; (4) other devices and/or applications generating patient data; (5) the CDS/WM system 110, such as a user input device thereof; and (6) one or more medical imaging system; (7) one or more biomarkers; and (8) the like. The consuming clinical applications 164 suitably include at least one of: (1) one or more of the clinical devices 102; (2) the patient information system 106; (3) one or more of the auxiliary systems 108; (4) applications running on devices (e.g., PCs, cell-phones, etc.); (5) the CDS/WM system 110; and (6) the like. In certain embodiments, one or more of the components of the IT infrastructure 100 belong to both the clinical data sources 162 and the consuming clinical applications 164. It is also contemplated that the clinical devices 102 are both a producer and a consumer of patient data.

The CDS/WM system 110, as discussed in detail below, includes various components which provide the quantified and statistical information presented in a form which supports interpretation of the collected data, provide the diagnostic probability that a current patient belongs to the normal, mild cognitively impaired (MCI), or AD patient groups, provide the general reports on patients visits, such as a summary of the impression of the patients first interview, a summary of the patients risk analysis results, and summary of findings on scans, along with the images, and provide the clinical recommendations based on clinical protocols and/or clinical guidelines. Each component of the CDS/WM system 110 may be employed before, during and after patients' visits. The patient data may be inputted and used before the patients' visit such as when supporting staff input patient information before examination or when the patients input their information by themselves using internet.

With reference to FIG. 2, a detailed view of the functional components of the CDS/WM system 110 according to aspects of the present disclosure is provided. The CDS/WM system 110 suitably includes a data viewing engine 166, a risk analysis engine 168, a computer interpretable guideline (CIG) database 170, an instances database 172, a reporting engine 174, and the like. It is to be appreciated these functional components are merely abstractions to simplify the discussion hereafter and are not intended to be construed as limiting the structural layout of the CDS/WM system 110. It is also appreciated that each of these components may also be incorporated into the clinical data sources 162 and/or consuming clinical applications 164.

The data viewing engine 166 provides quantified and statistical information for display on the consuming clinical application 164 in a form which supports interpretation of the collected patient data. The data viewing engine 166 provides a user interface to display the statistical data as well as a clear comparison of the patient data to suitable reference data representative of a suitable comparison population. To generate the user interface, the data viewing engine 166 receives patient data from the clinical data sources 162. The data viewing engine 166 then generates and controls a display of the CDS/WM system 100 and/or the consuming clinical applications 164 to display the patient data received from the clinical data sources 162. Specifically, the data viewing engine 166 generates and displays non-biased quantified information from the received patient data. The data viewing engine 166 also provides a statistical model for each data type of the patient data. For example, for each data type, the data viewing engine 166 displays selected patient data relative to the most similar statistical model for a normal, diseased, or mildly diseased population.

In order to provide quantified information, the data viewing engine 166 utilizes a data model for each value which provides neurologists a global view of the population of normal controls, patients with disease, and the patients with mild cognitive impairment. The data models indicates how the current patient's evaluation compares to the different diagnostic groups of the population utilizing percentile ranges and thresholds that separate the diagnostic classes. To generate the quantified information, the data viewing engine 166 utilizes statistical models based on historic patient data, published clinical data and results, clinical literature, and the like stored in the clinical data sources. The data viewing engine 166 also calculates feature percentile ranges and feature value changes of a current patient from historic patient data stored in the clinical data sources 162.

The data viewing engine 166 also provides the quantitative information utilizing unbiased data values. For instance, the data viewing engine 166 provides a long term prediction of a diagnostic class such as a prognosis of cognitive function level at a future time. To accomplish this, the data viewing engine 166 utilizes the patient data at the current time and in past time periods, when available, to reflect the patient's change rate. The data viewing engine 166 also includes patient data from family members of the patients which are stored in the clinical data sources to assist in determining the cognitive functions of a patient. In this way, the neurologists remains sensitive to patients who, for example, score higher on tests because of their higher education but have already shown indications of declined cognitive functions. The data viewing engine 166 also provides unbiased diagnosis utilizing the patient data obtained during the current visit or other data obtained during another visit at different time point. It is also contemplated that the CDS/WM station enables neurologists to exclude patient data that is deemed irrelevant or biased.

The data viewing engine 166 also provides quantified analysis of the received patient data including screening evaluations such as psychological tests, biomarkers, image data, and the like. The purpose of this quantification is to enable comparison of the patient data to typical ranges of variability within a population of normal control subjects, patients with confirmed forms of specified diseases, patients with prodromal disease (MCI), and the like. For example, the data viewing engine 166 generates and displays a diagram displaying the average score that normal patients typically record, the average score that MCI patients typically record, the average score that AD patients obtain, and the current patient's score. Such reference values are obtained from the clinical data sources 162 of the CDS/WM system 100. It is also contemplated that the reference values are input from literature, research models, and the like stored in the clinical data sources 162. It is also contemplated that the reference values include percentile values, standard error about the mean, and the like. To support in the interpretation of the patient data, the data viewing engine 166 positions the current patient's score corresponding to the position of reference values. For example, if a current patient's score sits between MCI and AD, the neurologist is given a direct impression that the patient's current status is closer to a transition from MCI to AD. The data viewing engine 166 also provides analysis and trending information of biomarker information such as gene-based biomarkers, such as amyloid beta (A•) accumulation sampled from cerebrospinal fluid (CSF). The data viewing engine 166 also provides quantified information of medical images. For example, the data viewing engine provides information on hippocampus volume and the ventricle size determined from MRI images and metabolism levels depicts in PET images.

The data viewing engine 166 also provides a prognosis of dementia progression based on single point data. It has been widely acknowledged that the same histological pathology of AD is found across a broad clinical spectrum. Several explanations have been offered for this fact, for example, cognitive reserve effect, brain compensating capacity. With help of medical imaging techniques, for example, functional MRI (fMRI), more scattered brain activity was observed in patients with advanced AD pathology, but showing little clinical cognitive impairment. This observation indicates that functions of a possibly handicapped brain area due to AD may be compensated by other part of the brain. This compensating capacity can delay appearance of clinical dementia and/or slow dementia progression despite steady pathological progression of AD. By properly measuring this compensating capacity, a reliable prognosis of dementia progression can be made based on single-point patient data. Although such compensating capacity may vary from person to person and from time to time, it is still possible to sort out patients with similar compensating capacity into subgroups. Therefore, correlation between AD pathology and clinical cognitive impairment of each subgroup can be stronger than that of the total population.

To provide a prognosis of dementia progression based on single point data, the date viewing engine 166 calculates a statistic correlation curve between a cognitive impairment staging scale based on at least one psychological test score and a biomarker staging scale of a sufficiently large population with at least 30% population with dementia indication ranging from early stage to late stage. The biomarker staging scale being built on at least one specific protein concentration and at least one brain anatomic feature with each normalized to known healthy baseline values and applied with a proper weighting factor. The data viewing engine 166 then sorts individuals of the population into at least three subgroups according to their distance of the cognitive impairment scale at a given biomarker staging scale to the statistic correlation curve at the corresponding biomarker staging scale. The data viewing engine 166 calculates a group statistic correlation of each the subgroup between cognitive impairment staging scale and biomarker staging scale. The data viewing engine 166 then examines a patient's cognitive impairment staging scale and biomarker staging scale and identifies its best matching subgroup according to its distance of cognitive impairment staging scale to the statistic correlation curve. A prognosis of cognitive impairment progression of the patient is determined by utilizing the group statistic correlation of the best matching subgroup. The data viewing engine 166 chooses a proper threshold correlation coefficient to determine optimal grouping of the subgroups. It is also contemplated that a threshold miscorrelation be chosen to ensure minimal crosstalk between the subgroups. Further, patient data can be adjusted for ages, education, profession, and the like to minimize bias. For example, diagnosis data of a large patient population is analyzed with the same category of diagnosis data over a proper time span. At least two biomarkers are used to generate the biomarker staging scale. At least one of the following clinical neuropsychological scores MMSE, CERAD, and CDR is used to generate the cognitive impairment staging scale. Each set of patient data are adjusted for ages and other applicable attributes and properly normalized, for example to known healthy values.

The risk analysis engine 168 provides a probability of normal, MCI, AD respectively based on the patient data. It also provides a confidence level based on training data or statistic models. To provide the probability and confidence level, the risk analysis engine 168 analyzes the current patient data against patient data of populations of normal control subjects, patients with confirmed forms of specified diseases, patients with prodromal disease (MCI), and the like utilizing a bayesian analysis, statistical analysis, and the like. For example, the risk analysis engine 166 evaluates the patient data and accesses any optimal data features with the patient data. The reporting engine then utilizes the training data or statistical models to calculate the risk probability profiles and confidence level of the diagnosis of the patient data.

By default, the risk analysis engine 166 selects optimal features of the patient data to provide the probability, however, the user is also offered the choice of using any desired feature based on experience, preference or trust for specific tests. The risk analysis engine 168 also utilizes features from different time points of the patient data and provides users a flexible choice of any feature related for the diagnosis. The risk analysis engine 168 provides an automatic staging of the patient's cognitive impairment. In order to provide a complete analysis, the risk analysis engine 168 utilizes a model which provides a mechanism to select optimal features. In the clinical setting, situations may further arise whereby the available diagnostic information is incomplete, or that only a subset of test results is considered reliable. It is also contemplated that the risk analysis engine 168 is pre-configured with parameterized models trained with respect to all the foreseeable combinations of available features of the patient data.

The reporting engine 174 provide general reports on a patient's visits including a summary of the impression of the patient's first interview, a summary of the patient's risk analysis results, a summary of findings on scans along with the images, and the like. The reporting engine 174 also provides recommendations or guidelines to neurologists automatically including lifestyle change, next order of scans and tests, drug prescription, and the like based on all available information of patients, including neuropsychological tests, scans, and biomarkers.

The reporting engine 174 provides guidelines or recommendations embodying clinical protocols of the medical institution. A clinical protocol typically includes one or more preferred care steps and timing or sequence for an occurrence of the care step(s) as a function of patient information and clinical problem. Further, a clinical protocol typically includes recommendations to perform specific care steps, with associated instructions. It is contemplated that the clinical protocols are derived from clinical guidelines, but other approaches to deriving the clinical protocols are contemplated. Suitably, the guidelines or recommendations are stored within a guidelines database 170 and indexed by clinical problem. However, it is contemplated that the guidelines or recommendations are stored in other components of the medical institution.

To provide the recommendations or guidelines, the reporting engine 174 creates instances of the recommendations or guidelines stored in the guideline database 166 relevant to the clinical problems associated with the patients serviced by the medical institution. The guidelines and recommendations stored in the guidelines database 166 are created from published clinical guidelines, historic patient data, published clinical data and results literature, and the like. It is also contemplated that the guidelines and recommendations are provided by rules generated through a machine learning technique using historical patient data provided by the clinical data sources as a foundation and incorporating current patient visit information (and published clinical guidelines). For example, when a patient with a particular clinical problem is admitted to the medical institution, the CDS/WM system 110 locates one or more of the guidelines or recommendations in the guideline database 170 relevant to the patient and creates an instance for each one or more of these recommendations or guidelines for the patient. An instance of a recommendation or guideline is a copy of a recommendation or guideline tailored to a particular patient by applying patient and workflow data for that patient to the reporting engine logic. The instances are suitably maintained in the instances database 172 and indexed by patient. However, it is contemplated that the instances are stored in other components of the medical institution.

In order to provide a recommendation or guideline, the reporting engine 174 utilizes machine learning techniques to generate a statistical model with the inputs of quantified information derived from available patient data, such as the distance from the normal control, the percentile range, and the like and the diagnostic probability that the current patient belongs to the normal, mild cognitively impaired (MCI), or AD patient groups. The reporting engine 174 outputs a recommendation or guideline to perform a specific care step such as a suggestion or tips for lifestyle change, next order of scans and tests, a drug prescription, and the like. For example, the lifestyle change recommendation could be a suggestion to quit smoking, start performing brain-benefit activity/exercise 1-2 hours every day, computer games, piano, scenery walking, and the like.

In order to obtain an automatic recommendation for a visiting patient, the neurologist or supporting staff interfaces with the CDS/WM system such as clicking a button on which generates the recommendations based on the quantified information. In addition, the neurologist has the ability to reject the computerized optimal recommendation and instead select the information he/she wishes to include in the recommendation generation algorithm.

The reporting engine 174 further maintains and/or updates the instances of the recommendation or guideline. As patient data relevant to one or more of the instances becomes available, the one or more instances are updated to reflect the updated patient information. For example, as a care step is performed for a particular patient, it is contemplated that one or more associated instances are updated to reflect that the care step has been performed. Relevant patient data includes one or more of clinical data, workflow data, and the like. It is contemplated that the patient data is received directly from components of the medical institution, such as the sourcing clinical device(s), or indirectly via a component of the medical institution, such as the patient information system 106.

While the reporting engine 174 is executing the recommendation or guideline, the reporting engine 174 provides clinical knowledge based on the recommendation or guideline to the consuming medical device(s) and/or other components of the medical institution. It is also contemplated that the CDS/WM system 110 itself may be the only consuming medical device and provides recommendations and instructions to the user through its display. As noted above, a recommendation or guideline typically includes recommendations for care steps. Hence, as an instance of a recommendation or guideline is updated by, for example, completing a care step, recommendations and/or instructions for subsequent care steps are provided to relevant one or more of the consuming medical device(s). In certain embodiments, the relevant consuming medical device(s) are the consuming medical device(s) that registered with the CDS/WM system 110 to receive clinical knowledge pertaining to a patient.

The reporting engine 172 also enables neurologists to edit the recommendation or guideline. Furthermore, after the neurologist saves the recommendation for the current patient, the reporting engine 172 has the ability to update rules and recommendations for future analysis or patient visits, as well as save quantified information, diagnosis probability and prognosis results in the CDS/WM system 110. After the new recommendation is saved in the CDS/WM system 110, the reporting engine 174 will update the guideline recommendation algorithm to generate a future recommendation.

Further, as used herein, a memory includes one or more of a non-transient computer readable medium; a magnetic disk or other magnetic storage medium; an optical disk or other optical storage medium; a random access memory (RAM), read-only memory (ROM), or other electronic memory device or chip or set of operatively interconnected chips; an Internet server from which the stored instructions may be retrieved via the Internet or a local area network; or so forth. Further, as used herein, a engine includes one or more of a microprocessor, a microcontroller, a graphic processing unit (GPU), an application-specific integrated circuit (ASIC), a field-programmable gate array (FPGA), and the like; a communications network includes one or more of the Internet, a local area network, a wide area network, a wireless network, a wired network, a cellular network, a data bus, such as USB and I2C, and the like; a user input device includes one or more of a mouse, a keyboard, a touch screen display, one or more buttons, one or more switches, one or more toggles, and the like; and a display includes one or more of a LCD display, an LED display, a plasma display, a projection display, a touch screen display, and the like.

With reference to FIG. 3, a data input interface 200 of a CDS/WM system is illustrated. As mentioned above, the data input interface 200 enables neurologists or supporting staff to input patient data and clinical information into the EMR of a patient including information gathered from the patient's first interview by neurologists. For example, the data input interface 200 includes patient information sectors 202 in which neurologist or supporting staff input the patient's name 204, ID 206, birth day 208, visit date 210, years of education 212, gender 214, and the like. The data input interface 200 also includes family history sectors 216 which enable the neurologist or supporting staff to input the patient's family history including information relating to first degree relatives 218, age at death of the first degree relatives 220, AD diagnosis of first degree relatives 222, autopsy information 224, stoke information 226, and the like. It is also contemplated that the data input interface 200 include a suitable component which enables patients or their relatives to input their own demographic information, such as age, years of education, gender, and the like. The data input interface 200 further includes sectors which allow the neurologist to input information corresponding to the assessment on the patient's first impression on signs of AD 228 including the significance of memory loss 230, challenges in mental capacity 232, difficulty completing familiar tasks 234, confusion of time and place 236, trouble understanding visual images and spatial relationships 238, problems with speaking and writing 240, ability to retrace steps or remember locations 242, decreased or poor judgment 244, withdrawal from work or social environments 246, changes in mood or personality 248, and the like. The data input interface 200 also includes a comments sector 250 which enables the neurologist or support staff to input any additional patient or clinical information into CDS/WM system. The data input interface 200 also enables users to select whether the system will integrate the local database with the Picture Archiving Communication system and the like 252. It should be appreciated that the data input interface 200 includes other sectors that enables a neurologist or supporting staff to input various patient and clinical information.

FIG. 4 illustrates a data viewing interface 300 of a CDS/WM system. The data viewing interface 300 provides quantified and statistical information, presented in a form which supports interpretation of the collected data. The data viewing engine not only provides a user interface to show the statistical data, but also provides a clear comparison of the data to suitable reference data representative of a suitable comparison population. Specifically, the data viewing engine 300 provides quantified analysis of the above types of data, including screening evaluations 302 such as psychological tests 304, biomarkers 306, and scans 308, and the like. For physiological tests 304, the data viewing interface 300 displays quantified information that enables comparison to typical range of variability within a population of normal control subjects, patient's with confirmed forms of specified diseases, as well as patients with prodromal disease, often termed mild cognitive impairment (MCI). Specifically, the data viewing interface 300 enables a neurologist or supporting staff to view the results or scores from a particular physiological test including MMSE, AD8, and the like. For example, the data viewing interface 300 includes a diagram 310 displaying the average score that normal patients typically record 312, the average score that MCI patients typically record 314, and the average score that AD patients obtain 316, enabling comparison to the current patient's score 318. As shown, the current patient's score sits between MCI and AD, which gives physicians a direct impression that this patient's current status is closer to a transition from MCI to AD. The data viewing interface 300 also includes a diagram 320 which illustrates the change in the patient's MMSE score in the last three years. The data viewing interface 300 also displays the detailed results 322 from the physiological test or the results for each question on MMSE test. The data viewing interface 300 also includes a summary of the patient information 324 and a timeline of the visit history of the patient 326. It should be appreciated that the data viewing interface 300 displays other patient and clinical information enables a neurologist or supporting staff to interpret the results of physiological tests. It should also be contemplated that the data viewing interface 300 is customizable by the viewing neurological or supporting staff.

FIG. 5 illustrates another data viewing interface 400 of a CDS/WM system. The data viewing engine 400 provides quantified analysis of the above types of data, including screening evaluations 402 such as psychological tests 404, biomarkers 406, and scans 408, and the like. For biomarker information 406, the data viewing interface 300 displays quantified information of results from various biomarkers including Cerebrospinal fluid (CSF), APOE 4 genotype, and the like. For example, the data viewing interface 400 displays quantified information relating to CSF, which is obtained most commonly by lumbar puncture (usually between the third and fourth lumbar vertebrae). AD (the accumulation of amyloid plaques) is highly correlated with betaamyloid(42), tau, tau181, tau/beta-amyloid(42) and tau(181)/beta-amyloid(42). As shown in the data viewing interface 400, information for each biomarker for the current patient is displayed in a diagram 410 in a trending format over time. In each diagram 410, the mean of normal value of the information is displayed along with the current patient's value. For example, beta-amyloid shows decreasing trend and the value is lower than the mean values, while tau, tau181, tau/beta-amyloid(42) and tau(181)/beta-amyloid(42) show increasing trend, the values are above the mean values respectively which are typical trends for the MCI and AD patients. It should be appreciated that the data viewing interface 400 displays other biomarker information enables a neurologist or supporting staff to interpret the results of biomarkers. It should also be contemplated that the data viewing interface 400 is customizable by the viewing neurological or supporting staff.

With reference to FIG. 6, another data viewing interface 500 of a CDS/WM system is illustrated. The data viewing engine 500 provides quantified analysis of the above types of data, including screening evaluations 502 such as psychological tests 504, biomarkers 506, and scans 508, and the like. For scans 508, the data viewing interface 500 displays quantified information of results from various medical images including MRI, FDG-PET, PIB, and the like. For example, the data viewing interface 500 displays FDG-PET images 510 (FDG is a radiolabeled-glucose) depicting the metabolism level at each location of the patient. The data viewing interface 500 stereotactically normalizes (i.e. elastic registration to a template image) the images to ease in interpretation. This allows voxel-wise comparison to a normal collective of healthy patients. Statistical testing enables identification of significant hypo-metabolism. Spatial distribution (pattern) of hypometabolism is indicative of a specific disease. It should also be appreciated that the data viewing interface 500 also provide quantified information of MRI images, for instance volumes of hippocampus and the ventricle size. It is known that the volume of hippocampus will shrink significantly for AD patients comparing with normal patients. For, MRI images the data viewing interface 500 provides trending information of the volumes of hippocampus and the ventricle size as well as various MRI images of the patient taken at various times. It should be appreciated that the data viewing interface 500 displays other scan information enables a neurologist or supporting staff to interpret the results of scans. It should also be contemplated that the data viewing interface 500 is customizable by the viewing neurological or supporting staff.

With reference to FIG. 7, a risk analysis interface 600 of a CDS/WM system is illustrated. The risk analysis interface provides probability diagram of the probability of normal, MCI, and AD diagnosis 602 respectively. The risk analysis interface also provides a confidence level diagram 604 of the probability of normal, MCI, and AD. The risk analysis interface 600 also allows neurologists or supporting staff to select which information is taken into account when determining the probability of normal, MCI, and AD. For example, the risk analysis interface 600 includes the screening evaluations such as psychological tests 606, biomarkers 608, and scans 610, and the like. The risk analysis interface 600 also includes a summary of the patient information 612 and a timeline of the visit history of the patient 614. It should be appreciated that the risk analysis interface 600 displays other risk analysis and probability information which enables a neurologist or supporting staff to interpret risk associated with the various diagnoses. It should also be contemplated that the risk analysis interface 600 is customizable by the viewing neurological or supporting staff.

FIG. 8 illustrates a reporting interface 700 of a CDS/WM system. The reporting interface 700 provides general reports on patient's visits, such as a summary of the impression of the patient's first interview, a summary of the patient's risk analysis results, and summary of findings on scans, along with the images. The reporting interface 700 also provides recommendation to neurologists automatically, such as lifestyle change, next order of scans and tests, drug prescription etc., based on all available information of patients, including neuropsychological tests, scans, and biomarkers. The reporting interface 700 also allows neurologists to edit the recommendation 702. The reporting interface 700 includes a first interview summary for a patient 706, a diagnostics summary 708, and a recommendation on drug prescription, life style change, and the like 710. The reporting interface 700 also displays the workflow data 712 associated with the patient and a summary of the patient information 714. It should be appreciated that the reporting interface 700 displays other reporting information which enables a neurologist or supporting staff to view other reports or recommendations. It should also be contemplated that the reporting interface 700 is customizable by the viewing neurological or supporting staff.

FIG. 9 illustrates a median correlation curve 800 interface of the CDS/WM system. The median correlation curve 800 between biomarker assessment and clinical neuropsychological scores is generated from clinical data of a large population as a reference. The data of a patient are compared with the median correlation and its neuropsychological score distance to the correlation curve is measured as individual brain compensating capacity. This compensating capacity is used to calibrate prognosis of individual's dementia progression. The median correlation curve interface 800 includes a correlation curve of subgroup with its cognitive impairment distance above that of the base population 802, a correlation curve of the whole population 804, and a correlation curve of subgroup with its cognitive impairment distance below that of the base population 806. The medium correlation curve interface 800 also includes mean square error boundary of whole population 808. To make a prognosis for dementia progression, process a patient's data of single time-point for proper adjustment and normalization to get corresponding scale parameters. Examine its distance of cognitive impairment scale to the correlation curve of the whole base population, determine its subgroup affiliation and use the correlation of the matching subgroup to derive dementia progression of the patient.

FIG. 10 illustrates the operation of a CDS/WM system 900 according to aspects of the present disclosure. In a step 902, a neurologist starts an automatic system to generate a recommendation for a current patient. In a step 904, image features are calculated from available scans for the new case. In a step 906, all valuable non-imaged information (tests, gene-typed information) are fetched. In a step 908, quantified information based on the statistical models for each data is generated. In a step 910, a diagnosis of normal, MCI, or AD is determined. In a step 912, a model of recommendation is generated. In a step 914, a recommendation is presented to the neurologist.

FIG. 11 illustrates another operation of a CDS/WM system 1000 according to aspects of the present disclosure. In a step 1002, biomarker staging scale and cognitive impairment stating scale from raw data for each patient of a large population is calculated. In a step 1004, a statistic correlation curve between two scale parameters of the whole population is calculated. In a step 1006, patient data is sorted into at least three subgroups according to their distance of cognitive impairment scale to the correlation curve of the whole population. In a step 1008, a statistic correlation curve between two scale parameters of each subgroup is calculated. In a step 1010, the patient data of one time-point of a patient who is going to be prognosticated is processed and examined to find the best matching subgroup according to its distance of cognitive impairment scale to said correlation curve of the whole population. In a step 1012, the correlation curve of the matching group is used to prognosticate progression of cognitive impairment of the patient.

The invention has been described with reference to the preferred embodiments. Modifications and alterations may occur to others upon reading and understanding the preceding detailed description. It is intended that the invention be constructed as including all such modification and alterations insofar as they come within the scope of the appended claims or the equivalents thereof.

1. A system for improving workflow, the system comprising:
one or more clinical data sources which collect patient data from a patient;
a patient information system which stores the patient data; and
a clinical decision support system including:
one or more processors as defined in claim 21.

2. (canceled)

3. (canceled)

4. (canceled)

5. (canceled)

6. The system according to claim 1, wherein the recommendation is at least one of a lifestyle change, next order of scans or tests, and a drug prescription.

7. (canceled)

8. A method for improving workflow, the method comprising:
receiving patient data for a patient, the patient data including clinical data collected from the patient;
generating quantified information based on a statistical model for each type of patient data;
diagnosing the patient based on the quantified information;
generating a recommendation based on the diagnosis and the quantified information; and
displaying the recommendation
characterized in that
the clinical data comprises psychological test data and biomarker data;
wherein the quantified information comprises a patient biomarker staging scale and a patient cognitive impairment scale, wherein the patient biomarker staging scale and the patient cognitive impairment scale are calculated based on the psychological test data and the biomarker data;
wherein the method further comprises receiving a correlation curve between a population biomarker staging scale and a population cognitive impairment scale;
wherein diagnosing the patient further comprises comparing the patient biomarker staging scale and the patient cognitive impairment scale with the correlation curve.

9. (canceled)

10. The method according to claim 8, wherein the diagnosis includes a normal patient, mild cognitively impairment, and Alzheimer's disease.

11. The method according to claim 8, further including:
displaying the quantified information and reference data representative of a suitable comparison group.

12. The method according to claim 8, further including:
calculate a probability and a confidence level of the diagnosis.

13. One or more processors preprogrammed to perform the method according to claim 8.

14. A computer readable medium carrying software which controls one or more processors to perform the method according to claim 8.

15. (canceled)

16. (canceled)

17. The method according to either one of claims 15 and 16, further including:
calculating a correlation curve between two scale parameters of each subgroup; and
matching the subgroup according to its distance of cognitive impairment scale to the correlation curve of the whole population.

18. The method according to any one of claim 15-17, wherein the correlation curve of the matching subgroup is used to prognosticate the cognitive impairment of the patient.

19. One or more processors preprogrammed to perform the method according to any one of claims 15-18.

20. A computer readable medium carrying software which controls one or more processors to perform the method according to any one of claims 15-18.

21. A method for improving workflow, the method comprising:
receiving patient data for a patient, the patient data including clinical data collected from the patient;
generating quantified information based on a statistical model for each type of patient data;
diagnosing the patient based on the quantified information; and
generating a recommendation based on the diagnosis and the quantified information;
displaying the recommendation;
characterized in that
the clinical data comprises psychological test data and biomarker data;
wherein the quantified information comprises a patient biomarker staging scale and a patient cognitive impairment scale, wherein the patient biomarker staging scale and the patient cognitive impairment scale are calculated based on the psychological test data and the biomarker data;
wherein the method further comprises receiving a correlation curve between a population biomarker staging scale and a population cognitive impairment scale;
wherein diagnosing the patient further comprises comparing the patient biomarker staging scale and the patient cognitive impairment scale with the correlation curve.
